(19) United States
(12) Patent Application Publication
(10) Pub. No.: US 2013/0165136 A1
(43) Pub. Date: Jun. 27, 2013

(54) SYSTEM AND METHOD FOR MANAGING RESOURCES IN A COMMUNICATION SYSTEM

(71) Applicants: Kyu-Min Kang, Daejeon (KR); Sang-In Cho, Daejeon (KR); Hyunduk Kang, Daejeon (KR); Heon-Jin Hong, Daejeon (KR); Chang-Joo Kim, Daejeon (KR)

(72) Inventors: Kyu-Min Kang, Daejeon (KR); Sang-In Cho, Daejeon (KR); Hyunduk Kang, Daejeon (KR); Heon-Jin Hong, Daejeon (KR); Chang-Joo Kim, Daejeon (KR)

(73) Assignee: Electronics and Telecommunications Research Institute, Daejeon (KR)

(21) Appl. No.: 13/821,736

(22) PCT Filed: Sep. 9, 2011
(86) PCT No.: PCT/KR2011/006730

§ 371 Date: Mar. 8, 2013

(30) Foreign Application Priority Data
Sep. 10, 2010 (KR) 10-2010-0089030
Sep. 8, 2011 (KR) 10-2011-0091371

(51) Int. Cl. H04W 16/14

(52) U.S. Cl. CPC H04W 16/14
USPC 455/454

(57) ABSTRACT

The present invention relates to a system and method for managing resources, which involve managing a plurality of frequency resources in a communication system including a plurality of systems not having rights to use a first frequency band. The system and method of the present invention involve: defining, upon the detection of a frequency band available to the plurality of systems from the first frequency band, an interface between objects in the available frequency band so as to enable coexistence and frequency-sharing among the plurality of systems in the available frequency band; defining a primitive of a service access point (SAP) which supports the transceiving of information belonging to the plurality of systems between the objects through the interface; enabling the objects to transceive information belonging to the plurality of systems through the interface using the primitive of the service access point; and enabling the plurality of systems to coexist and share a frequency in the available frequency band to use the available frequency band by transceiving the information belonging to the plurality of systems.

### CROSS-REFERENCES TO RELATED APPLICATIONS

The present application claims priority of Korean Patent Application Nos. 10-2010-0089030 and 10-2011-0091371, filed on Sep. 10, 2010, and Sep. 8, 2011, respectively, which are incorporated herein by reference in their entirety.

### BACKGROUND OF THE INVENTION

1. Field of the Invention

Exemplary embodiments of the present invention relate to a communication system; and, more particularly, to a resource management system and method for managing a plurality of resources shared in a communication system.

2. Description of Related Art

In current communication systems, studies have been actively conducted to provide users with services which have various qualities of service (hereinafter referred to as ‘QoS’) at a high transmission speed. In the communication systems, studies have been actively conducted to provide a large-capacity service having various QoS requirements using a limited resource, e.g., a frequency resource. Particularly, with the development of radio communication technologies and the introduction of new radio communication services, it is necessary that the finite frequency resource should be more efficiently used.

Plans for maximizing spectrum efficiency through the optimization of a communication system, e.g., multi-access, coding, modulation, information compression, etc. and minimizing interference with another communication system have been proposed as plans for improving the usage efficiency of the finite frequency resource in the communication system. There has been proposed a plan for improving the usage efficiency of the frequency resource by utilizing an available frequency band in a previously used frequency band such as a TV band.

Here, the frequency sharing in an available frequency band in the previously used frequency band such as the TV band should be performed by utilizing the available frequency band without interfering with a primary incumbent having a prior right to use the TV band. Therefore, it is important to identify the presence of use of the frequency band of the primary incumbent in the TV band and then detect an available frequency band in the TV band. When there exist a plurality of different systems intended to use the available frequency band detected in the TV band, a problem in coexistence for utilizing the available frequency band occurs due to a difference in communication method, e.g., radio access method between the plurality of different systems.

That is, in the current communication systems, when a plurality of different systems exist to use the available frequency band detected in the TV band as described above, there exists no specific resource management plan in which the plurality of different systems efficiently use the detected available frequency band. Particularly, a specific plan for efficiently utilizing the frequency band when systems of different communication methods coexist to use the available frequency band has not been proposed.

Therefore, it is required to propose a resource management plan for detecting an available frequency band in a previously used frequency band such as a TV band in a communication system and then efficiently utilizing the detected available frequency band when a plurality of different systems, e.g., system of different communication methods coexist.

### SUMMARY OF THE INVENTION

An embodiment of the present invention is directed to a resource management system and method in a communication system.

Another embodiment of the present invention is directed to a resource management system and method for efficiently utilizing an available frequency band in a previously used frequency band through coexistence of a plurality of systems in a communication system.

Another embodiment of the present invention is directed to a resource management system and method for managing a frequency resource so that a plurality of systems an available frequency band in a TV band through transmission/reception of signals according to interfaces for coexistence and frequency sharing of the plurality of systems in a communication system.

Another embodiment of the present invention is directed to a resource management system and method for managing a frequency resource so that a plurality of systems use an available frequency band in a TV band by defining primitives for transmission/reception of signals according to interfaces for coexistence and frequency sharing of the plurality of systems in a communication system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a resource management system in a communication system including a plurality of systems having no right to use a first frequency band includes a coexistence manager (CM) configured to manage the plurality of systems for the purpose of existence and frequency sharing of the plurality of systems in a frequency band available for the plurality of systems, when the available frequency band is detected in the first frequency band; a coexistence enabler (CE) configured to transmit/receive information of the plurality of systems; and a coexistence discovery and information server (CDIS) configured to support a control of the CM for the plurality of systems. In the system, the information of the plurality of systems are transmitted/received between the CM, the CE and the CDIS according to interfaces defined between the CM, the CE and the CDIS, and each of the CM, the CE and the CDIS includes a service access point (SAP) for supporting the transmission/reception of the plurality of systems through the interfaces.

In accordance with another embodiment of the present invention, a resource management method for managing a resource of a first frequency band in a communication system including a plurality of systems having no right to use the first frequency band includes defining interfaces between objects in a frequency band available for the plurality of systems for the purpose of existence and frequency sharing of the plurality of systems in the available frequency band, when the available frequency band is detected in the first frequency band; defining primitives of SAPs for supporting transmission/reception of information of the plurality of systems between the objects through the interfaces; transmitting/receiving, by the objects, the information of the plurality of systems using the primitives of the SAPs through the interfaces; and using, by the plurality of systems, the available frequency band by transmitting/receiving the information of the plurality of systems for the purpose of coexistence and frequency sharing of the plurality of systems in the available frequency band.

### BRIEF DESCRIPTION OF THE DRAWINGS

FIG. 1 is a block diagram schematically illustrating a structure of a resource management system in a communication system in accordance with an embodiment of the present invention.

FIG. 2 is a flowchart schematically illustrating an operation of the resource management system in the communication system in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention proposes a resource management system and method for efficiently detecting and utilizing an available frequency band in a previously used frequency band such as a TV band in a communication system, e.g., a cognitive radio (hereinafter, referred to as ‘CR’) system, system based on IEEE 802.19 or system based on IEEE 802.22. In embodiments of the present invention, the CR system, the system based on IEEE 802.19 or the system based on IEEE 802.22 is described as an example. However, the resource management system and method proposed in the present invention may be applied to other systems.

In the embodiments of the present invention, there is proposed a resource management system and method for defining interfaces for coexistence and frequency sharing of a plurality of different systems and primitives for the interfaces and transmitting/receiving signals through the defined interfaces and primitives, so that the plurality of systems efficiently use an available frequency band in a TV band through the coexistence and frequency sharing of the plurality of systems in a communication system. In the embodiments of the present invention, the resource management system in the communication system defines interfaces between objects for sharing the available frequency band, and defines primitives of a device entity service access point (hereinafter, referred to as ‘SAP’) or device management entity SAP, e.g., coexistence device management entity SAP (hereinafter, referred to as a ‘CX_DME_SAP’), as an SAP that supports the defined interfaces and supports communications between different management objects for the coexistence and frequency sharing of the plurality of systems.

In the embodiments of the present invention, SAPs, i.e., the device entity SAP, device management entity SAP and CX_DME_SAP are included in each of the objects of the resource management system so as to support the signal transmission/reception between the objects of the resource management system for the purpose of the coexistence and frequency sharing of the plurality of systems in the available frequency band. For convenience of illustration, it will be mainly described that the CX_DME_SAP is included in each of the objects of the resource management system. In the embodiment of the present invention, the resource management system defines interfaces for the purpose of the signal transmission between the objects of the resource management system, and defines primitives of an SAP supporting the signal transmission/reception through the defined interfaces. In the embodiments of the present invention, the objects of the resource management system transmit/receive signals according to the defined interfaces and primitives, so that a plurality of different systems, particularly systems of different communication methods, e.g., systems of a radio access method share an available frequency band in a previously used frequency band such as a TV band for the purpose of coexistence of the plurality of systems.

That is, in the embodiments of the present invention, the resource management system proposes interfaces and primitives for the interface for the purpose of coexistence and frequency sharing of a plurality of different systems in a communication system. Thus, the plurality of systems transmit/receive signals between objects through the interfaces and primitives, particularly transmit/receive information for the coexistence and frequency sharing of the plurality of systems, so that the plurality of systems share an available frequency band. Accordingly, it is possible to improve the usage efficiency of a limited frequency resource.

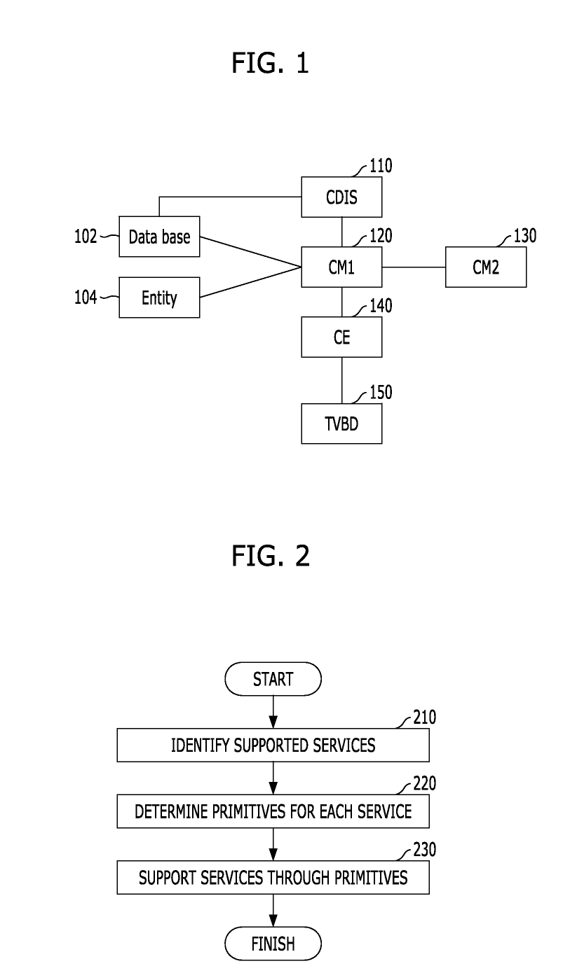

In the embodiments of the present invention, the plurality of systems share an available frequency band in a previously used frequency band such as a TV band. In this case, the available frequency band is necessarily used without interfering with an incumbent having a preferential right to use the TV band. Therefore, the available frequency band is detected by identifying the presence of use of the frequency band of the incumbent in the TV band, and a plurality of different systems intended to use the detected available frequency ban in the TV band use the available frequency band through the coexistence and frequency sharing of the plurality of systems. Hereinafter, a resource management system in accordance with an embodiment of the present invention will be described in detail with reference to FIG. 1.

FIG. 1 is a block diagram schematically illustrating a structure of a resource management system in a communication system in accordance with an embodiment of the present invention.

Referring to FIG. 1, when a plurality of different systems intend to us an available frequency band in a previously used frequency band such as a TV band, the resource management system includes sharing devices intended to use the available frequency band through frequency sharing in the plurality of different systems, e.g., a TV band device (hereinafter, referred to as a ‘TVBD’) 150 intended to use the TV band, coexistence managers (hereinafter, referred to as ‘CMs’), e.g., a CM1 120 and a CM2 130, which manage TVBDs of the plurality of different systems so as to improve the frequency sharing efficiency of the TVBD 150, a coexistence enabler (hereinafter, referred to as a ‘CE’) 140 which performs the function of a path between the TVBD 150 and the CM1 120, and a server, e.g., a coexistence discovery and information server (hereinafter, referred to as a ‘CIDS’) 110, which supports the control of TVBDs of the CMs 120 and 130. The resource management system may further include a database 102 in a TV white space (hereinafter, referred to as a ‘TVWS’), which interacts with external devices, e.g., systems based on IEEE 802.19.

When a primary incumbent (hereinafter, referred to as a ‘primary system’) previously having a right to use the TV band does not use a predetermined frequency band in the TV band, the TVBDs 150 mean a plurality of different systems of other users (hereinafter, referred to as ‘secondary systems’), i.e., devices of the secondary systems having no preferential right to use the TV band, which intend to use the predetermined frequency band detected as an available frequency band in the TV band. Here, the TVBDs 150 share the predetermined frequency band through coexistence and frequency sharing so as to more efficiently use a limited frequency resource.

The CE 140 transmits/receives information of the TVBD 150 and information of the CM1 120. In the embodiment of the present invention, it is mainly described that the CE 140 exists as an object independent of the TVBD 150 for convenience of illustration. However, the CE 140 may exist as an object independent of the TVBD 150 or may be included in the TVBD 150.

The CE 140 extracts context information related to the TVBD, requested by the CM1 120, e.g., information on the radio access method, transmit power, spectrum sensing threshold and location of the TVBD 150, from the TVBD 150 and transmits the extracted information to the CM1 120. That is, the CE 140 obtains communication related information of each of the plurality of systems, i.e., the secondary systems as the context information on each of the systems and transmits the obtained information to the CM1 120.

The CE 140 receives a request of the CM1 120 for managing the TVBD 150, e.g., a request for the contest information and configuration of the TVBD 150. The CE 140 updates the context information of the TVBD 150 according to the request and resets the configuration of the TVBD 150, i.e., reconfigures the configuration of the TVBD 150. The CE 140 receives changed information of the context information, i.e., event information of the TVBD 150 as a request for the context information of the TVBD 150, and updates the context information of the TVBD 150 according to the event information. In addition, the CE 140 receives configuration reset related information of TVBD 150, i.e., reconfiguration information as a request for the reconfiguration of the TVBD 150, and resets the configuration of the TVBD 150 according to the configuration reset related information, i.e., reconfigures the configuration of the TVBD 150 according to the reconfiguration information.

The CMs 120 and 130 determine the operation frequency assignment, transmit power assignment and transmit time assignment of the TVBD 150 so as to improve the frequency sharing efficiency of the TVBD 150. That is, the CMs 120 and 130 perform the operation frequency assignment, transmit power assignment and transmit time assignment of the TVBD 150 in the available frequency band so as to improve the frequency sharing efficiency of the TVBD 150 for the available frequency band in the TV band.

In order to more efficiently improve the frequency sharing efficiency of the TVBD 150, each of the CMs 120 and 130 performs the operation frequency assignment, transmit power assignment and transmit time assignment of corresponding TVBDs in the available frequency band by transmitting/receiving information with sharing devices not corresponding thereto, e.g., context and event information of the sharing devices. In this case, each of the CMs 120 and 130 obtains context and event information TVBDs not corresponding thereto by performing direct transmission/reception with other CMs or by performing direct transmission/reception with other CMs through the CDIS 110. In addition, each of the CMs 120 and 130 obtains information on the use of a spectrum in the primary system through the database 102 in the TVWS or requests other CMs of the configuration reset of TVBD corresponding thereto, i.e., requests the other CMs of reconfiguration information of the TVBD.

The CDIS 110 support a control operation of the CMs 120 and 130 for frequency sharing of the TVBD 150 with respect to the available frequency band in the TV band. That is, the CDIS 110 receives context and event information of the TVBD 150 from the CMs 120 and 130 and stores the received context and event information. The CDIS 110 transmits the context and event information of the TVBD 150 to the CMs 120 and 130 according to requests of the CMs 120 and 130. In addition, CDIS 110 receives the information on the use of the spectrum in the primary system, which the CMs 120 and 130 have obtained through the database 102 in the TVWS, from the CMs 120 and 130, and stores the received information.

The resource management system in the communication system in accordance with the embodiment of the present invention includes the CDIS 110, the CMs 120 and 130 and the CE 140 so that the secondary systems share the available frequency band in the previously used frequency band in the primary system, such as the TV band, i.e., for the purpose of the coexistence and frequency sharing of the TVBD 150. Here, the TVBDs 150 may be a base station (hereinafter, referred to as a ‘BS’), an access point (hereinafter, referred to as an ‘AP’), an SAP and a terminal as the devices of the secondary systems for sharing and using the available frequency band as described above. The secondary systems are a plurality of different systems for sharing the available frequency as described above, and may be systems of different communication methods, e.g., systems based on IEEE 802.19, IEEE 802.22 and the like.

The resource management system in the communication system in accordance with the embodiment of the present invention defines an interface and primitives for the interface for the coexistence and frequency sharing of each of the TVBDs of the plurality of systems with respect to the available frequency band in the previously used frequency band, i.e., so that the plurality of systems of different communication systems share the available frequency band in the previously used frequency band. Particularly, in the embodiment of the present invention, an interface for the coexistence and frequency sharing of different systems is defined for each of the CDIS 110, the CMs 120 and 130 and the CE 140, and different management objects, i.e., primitives for an SAP, e.g., CX_DME_SAP, which supports communications between the CDIS 110, the CMs 120 and 130 and the CE 140, are defined for the purpose of the support of the defined interface and the coexistence and frequency sharing of the plurality of systems. In the embodiment of the present invention, a reference model is also defined for the purpose of the coexistence and frequency sharing of different systems for each of the CDIS 110, the CMs 120 and 130 and the CE 140.

That is, the resource management system in the communication system in accordance with the embodiment of the present invention defines interfaces between the objects, i.e., between the CDIS 110, the CMs 120 and 130 and the CE 140. Particularly, the resource management system defines an interface between the CE 140 and the TVBD 150, an interface between the CM1 120 and the CE 140, an interface between the CM1 120 and the CDIS 110, an interface between the CMs 120 and 130, and an interface between the CM1 120 and the database 102. In addition, the resource management system defines primitives of a device management entity SAP supporting the interfaces, e.g., the CX_DME_SAP, which supports the interfaces. The resource management system defines services supported through the defined primitives, i.e. so that the context information of the TVBDs, the configuration reset related information, i.e., reconfiguration information of the TVBDs, and the event information of the TVBDs in the plurality of systems can be transmitted/received between the CDIS 110, the CMs 120 and 130 and the CE 140.

More specifically, in the embodiment of the present invention, the resource management system defines primitives for the device management entity SAP, i.e., CX_DME_SAP, which supports the interface between the CE 140 and the TVBD 150 in the system based on the IEEE 802.19, and defines services supported through the defined primitives, i.e. so that the context information of the TVBDs, the configuration reset related information, i.e., reconfiguration information of the TVBDs, and the event information of the TVBDs in the plurality of systems can be transmitted/received between the CDIS 110, the CMs 120 and 130 and the CE 140. Thus, the resource management system in accordance with the embodiment of the present invention more precisely identifies context information of TVBDs in a plurality of systems in the available frequency band, e.g., in the TVWS for the purpose of the coexistence and frequency sharing of the plurality of systems, and sets or resets configurations of the TVBDs so as to be suitable for frequency sharing environment of the TVWS. Further, the resource management system detects event information generated in the TVBDs, so that the TVWS is more efficiently used between different TVBDs or independently operated TVBDs in the TVWS.

Here, the resource management system in accordance with the embodiment of the present invention defines interface A as an interface for signal transmission/reception between the CE 140 and the TVBD 150, i.e., transmission/reception of context information, reset related information, i.e., reconfiguration information, and event information, and defines interface B1 as an interface for transmission/reception of the context information, reset related information and event information between the CE 140 and the CM1 120. The resource management system defines interface B2 as an interface for transmission/reception of the context information, reset related information and event information between the CM1 120 and the CDIS 110, and defines interface B3 as an interface for transmission/reception of the context information, reset related information and event information between the CM1 120 and the CM2 130. The resource management system in accordance with the embodiment of the present invention defines interface C as an interface for transmission/reception of the context information, reset related information and event information between the CM1 120 and the database 102.

When context information, reset related information and the event information of TVBDs are transmitted/received between the CDIS 110, the CMs 120 and 130 and the CE 140 through the defined interfaces for the purpose of the coexistence and frequency sharing of the plurality of systems, the CX_DME_SAP is included in each of the CDIS 110, the CMs 120 and 130 and the CE 140 so as to support the transmission/reception of the context information, reset related information and the event information. That is, the resource management system in accordance with the embodiment of the present invention allows the CX_DME_SAP to be included in each of the CDIS 110, the CMs 120 and 130 and the CE 140 so that the context information, reset related information and the event information are transmitted/received between the CDIS 110, the CMs 120 and 130 and the CE 140 through the defined interfaces.

Here, the CX_DME_SAP included in each of the CDIS 110, the CMs 120 and 130 and the CE 140 supports a context information service, a reset related information service and an event information service so as to transmit/receive the context information, reset related information and the event information. The resource management system defines primitives for the CX_DME_SAP so as to support the context information service, reset related information service and event information service of the CX_DME_SAP.

More specifically, when the CX_DME_SAP supports the context information service for the purpose of transmission/reception of the context information, the CE 140 obtains the context information of the TVBD 150 from the TVBD 150, i.e., obtains TVBD identifier (ID), TVBD type, TVBD radio interface, TVBD option, TVBD location information, TVBD measurement information, TVBD sensing threshold, TVBD transmit power level, TVBD cell area and TVBD reconfiguration capability information from the TVBD 150. The CE 140 transmits the obtained context information of the TVBD to the CM1 120. As the CX_DME_SAP supports the context information service for the purpose of transmission/reception of the context information, the CM1 120 transmits/receives the context information of the TVBD 150 to/from the CM2 130, the CDIS 110 and the database 102. Here, primitives of the CX_DME_SAP for supporting the context information service of the CX_DME_SAP are illustrated in Table 1.

TABLE 1
Primitives

TVBD_ID
TVBD_Type
TVBD_Radio_Interface
TVBD_Options
TVBD_Location
TVBD_Measurements
TVBD_Sensing_Threshold
TVBD_Transmit_Power_Level
TVBD_Coverage_Area
TVBD_Reconfiguration_Options

As illustrated in Table 1, the primitives of the CX_DME_SAP for supporting the context information service, i.e., context information service primitives include TVBD_ID, TVBD_Type, TVBD_Radio_Interface, TVBD_Options, TVBD_Location, TVBD_Measurements, TVBD_Sensing_Threshold, TVBD_Transmit_Power_Level, TVBD_Coverage_Area and TVBD_Reconfiguration_Options, so as to transmit/receive the context information of the TVBD 150.

The TVBD_ID means a primitive used by a CE so as to obtain an ID of a predetermined TVBD for coexistence and frequency sharing in a TVWS, and the TVBD_Type means a primitive used by the CE so as to identify a device kind of the predetermined TVBD in the TVWS. Here, the device kind of the predetermined TVBD is determined by a radio access method of the predetermined TVBD, or the like. The TVBD_Radio_Interface means a primitive used by the CE so as to identify a radio interface of the predetermined TVBD in the TVWS, and the TVBD_Options means a primitive used by the CE so as to identify options supported by the predetermined TVBD in the TVWS.

The TVBD_Location means a primitive used by the CE so as to identify a cell location of the predetermined TVBD in the TVWS, and the TVBD_Measurements means a primitive used by the CE so as to identify information measured by the predetermined TVBD, e.g., signal intensity measurement information, and the like. The TVBD Sensing Threshold means a primitive used by the CE so as to identify a sensing threshold when the predetermined TVBD in the TVWS detects the presence of existence of another TVBD in the TVWS in a course acquisition mode.

The TVBD_Transmit_Power_Level means a primitive used by the CE so as to identify a transmit power level of the predetermined TVBD in the TVWS, and the TVBD_Coverage_Area means a primitive used by the CE so as to identify a cell area of the predetermined TVBD in the TVWS. The TVBD_Reconfiguration_Options means a primitive used by the CE so as to identify a reconfiguration capability of the predetermined TVBD in the TVWS, i.e., to identify a reconfiguration capability according to the reset related information of the predetermined TVBD.

When the CX_DME_SAP supports the reset related information service for the purpose of transmission/reception of the reset related information, the CE 140 receives reset related information of the TVBD 150 from the CM1 120 for the purpose of coexistence and frequency sharing in the TVWS, i.e., receives a set or reset value, i.e., reset related information, for the configuration of the TVBD 150, related to TVBD channel assignment, TVBD time scheduling assignment, TVBD sensing threshold assignment, TVBD transmit power level assignment and TVBD cell area assignment. The CE 140 sets and resets the TVBD 150 by transmitting the received reset related information to the TVBD 150. As the CX_DME_SAP support the reset related information service for the purpose of transmission/reception of the reset related information, the CM1 120 transmits/receives the reset related information of the TVBD 150 to/from the CM2 130, the CDIS 110 and the database 102. Here, primitives of the CX_DME_SAP for supporting the reset related service of the CX_DEM_SAP are illustrated in Table 2.

TABLE 2
Primitives

TVBD_Channel_Assignment
TVBD_Time_Scheduling_Assignment
TVBD_Sensing_Threshold_Assignment
TVBD_Transmit_Power_Level_Assignment
TVBD_Coverage_Area_Assignment

As illustrated in Table. 2, the primitives of the CX_DME_SAP for supporting the reset related information are assignment related primitives for transmitting/receiving the reset related information of the TVBD 150, and include TVBD_Channel_Assignment, TVBD_Time_Scheduling_Assignment, TVBD_Sensing_Threshold_Assignment, TVBD_Transmit_Power_Level_Assignment and TVBD_Coverage_Area_Assignment.

The TVBD_Channel_Assignment means a primitive used by the CE so as to set or reset an operating channel list of the predetermined TVBD in the TVWS, and the TVBD_Time_Scheduling_Assignment means a primitive used by the CE so as to set or reset the time scheduling of a predetermined operating channel in the TVWS. The TVBD_Sensing_Threshold_Assignment means a primitive used by the CE so as to reset a sensing threshold level when the predetermined TVBD in the TVWS detects the presence of existence of another TVBD in the TVWS in the course acquisition mode.

The TVBD_Transmit_Power_Level_Assignment means a primitive used by the CE so as to reset a transmit power level of the predetermined TVBD in the TVWS, and the TVBD_Coverage_Area_Assignment means a primitive used by the CE so as to reset a cell area of the predetermined TVBD in the TVWS.

When the CX_DME_SAP supports the event information service for the purpose of transmission/reception of the event information, the CE 140 obtains the event information from the TVBD 150 for coexistence and frequency sharing in the TVWS, i.e., obtains TVBD location change information, TVBD measurement information,user sensing information, i.e., primary user sensing information of the TVBD 150 in the operating frequency of the TVBD 150, and user sensing information, i.e., secondary user sensing information of another TVBD in the operating frequency of the TVBD 150. The CE 140 transmits the obtained event information of the TVBD 150 to the CM1 120. As the CX_DME_SAP supports the event information service for the purpose of transmission/reception of the event information, the CM1 120 transmits/receives the event information to/from the CM2 130, the CDIS 110 and the database 102. Here, primitives of the CX_DME_SAP for supporting the event information service of the CX_DME_SAP are illustrated in Table 3.

TABLE 3
Primitives

TVBD_Location_Change
TVBD_Measurements_Change
TVBD_Incumbent_User_Detect
TVBD_Secondary_User_Detect

As illustrated in Table 3, the primitives of the CX_DME_SAP, i.e., event information service primitives, for supporting the event information service, include TVBD_Location_Change, TVBD_Measurements_Change, TVBD_Incumbent_User_Detect and TVBD_Secondary_User_Detect, for the purpose of transmission/reception of the event information of the TVBD 150.

The TVBD_Location_Change means a primitive used by the CE so as to periodically check and identify the presence of change of the cell area of the predetermined TVBD in the TVWS or a primitive used by the predetermined TVBD so as to inform the CE of information on the change cell area when the cell area of the predetermined TVBD is changed in the TVWS. The TVBD_Measurements_Change means a primitive used by the CE so as to periodically check and identify the presence of change of the information measured by the predetermined TVBD or a primitive used by the predetermined TVBD so as to inform the CE of information on the changed measurement when the information measured by the predetermined TVBD is changed in the TVWS.

The TVBD_Incumbent_User_Detect means a primitive used by the CE so as to periodically check and identify whether or not a primary user, i.e., incumbent user is detected by the predetermined TVBD in the TVWS or a primitive used by the predetermined TVBD so as to inform the CE of information on the detected primary user when the primary user is detected by the predetermined TVBD in the TVWS. The TVBD_Secondary_User_Detect means a primitive used by the CE so as to periodically check and identify whether or not a secondary user is detected by the predetermined TVBD in the TVWS or a primitive used by the predetermined TVBD so as to inform the CE of information on the detected secondary user when the secondary user is detected by the predetermined TVBD in the TVWS.

As described above, the resource management system in accordance with the present invention defines the primitives of the CX_DME_SAP supporting the transmission/reception of the context information, reset related information and event information of the plurality of systems between the objects, i.e., the CDIS, the CM, the CE and the TVBD, in the available frequency band, for the purpose of the coexistence and frequency sharing of the plurality of systems in the available frequency band. The resource management system defines services through the defined primitives of the CX_DME_SAP so that the CX_DME_SAP included in the CDIS, the CM, the CE and the TVBD transmits/receives the context information, reset related information and event information of the plurality of systems.

The definition of the interfaces for transmitting/receiving the context information, reset related information and event information of the plurality of systems between the CDIS, CM, CE and TVBD and the definition of the primitives of the CX_DME_SAP are made by the CM in the resource management system. That is, in the resource management system, the CM manages and controls the coexistence and frequency sharing of the plurality of systems in the available frequency band. Particularly, the CM defines the interfaces for transmitting/receiving the context information, reset related information and event information of the plurality of systems between the CDIS, CM, CE and TVBD. The CM also defines the primitives of the CX_DME_SAP supporting the transmission/reception of the information through the interfaces.

Thus, resource management system more precisely identifies the context information of the TVBD of the plurality of systems, and sets or resets the TVBD so as be suitable for the frequency sharing environment of the TVWS. Further, the resource management system detects the event information of each of the objects, generated in the TVBD, particularly event information of the TVBD, so that the plurality of systems more efficiently use the TVWS between different TVBDs or independently operated TVBDs through the coexistence and frequency sharing in the TVWS. Hereinafter, information transmission/reception between objects for the purpose of the coexistence and frequency sharing of the plurality of systems in the resource management system in accordance with the embodiment of the present invention with reference to FIG. 2.

FIG. 2 is a flowchart schematically illustrating an operation of the resource management system in the communication system in accordance with the embodiment of the present invention.

Referring to FIG. 2, at step 210, the resource management system identifies services supported by a CX_DME_SAP supporting signal transmission/reception between objects, i.e., a CDIS, a CM, a CE and a TVBD, for the purpose of the coexistence and frequency sharing of the plurality of systems in an available frequency band, e.g., TVWS. That is, the resource management system identifies the presence of support of context information service, reset related information service and event information service of the CX_DEM_SAP so that context information, reset related information and event information in TVBDs of the plurality of systems are transmitted/received between the CDIS, CM, CE and TVBD.

At step 220, the resource management system determines primitives of the CX_DME_SAP for the purpose of the support of the context information service, reset related information service and event information service of the CX_DME_SAP. That is, the resource management system defines primitives of the CX_DME_SAP for supporting the context information, defines primitives of the CX_DME_SAP for supporting the reset related information, and defines primitives of the CX_DME_SAP for supporting the event information, for the purpose of transmission/reception of the context information, reset related information and event information of the TVBDs of the plurality of systems between the CIDS, the CM, the CE and the TVBD. Here, the primitives of the CX_DME_SAP have been specifically described in Tables 1 to 3, and therefore, their detailed descriptions will be omitted.

At step 230, the resource management system supports the context information service, the reset related information service and the event information service through the primitives of the CX_DME_SAP so that the context information, reset related information and event information of the TVBDs of the plurality of systems are transmitted/received between the CDIS, CM, CE and TVBD. That is, the resource management system enables the coexistence and frequency sharing of the plurality of systems in the available frequency band by transmitting/receiving the context information, reset related information and event information of the plurality of systems between the CDIS, CM, CE and TVBD through the primitives of the CX_DME_SAP. Accordingly, the plurality of systems efficiently use the available frequency band.

In accordance with the exemplary embodiments of the present invention, the resource management system in the communication system determines interfaces for coexistence and frequency sharing of a plurality of systems and primitives for the interfaces, and transmits/receives signals through the defined interfaces and primitives, so as to manage a frequency resource so that the plurality of systems use an available frequency band in a previously used frequency band such as a TV band through the coexistence and frequency sharing of the plurality of systems. Accordingly, it is possible to improve the usage efficiency of the frequency resource by more efficiently utilizing the limited frequency resource.

While the present invention has been described with respect to the specific embodiments, it will be apparent to those skilled in the art that various changes and modifications may be made without departing from the spirit and scope of the invention as defined in the following claims.

What is claimed is:

1. A resource management system in a communication system comprising a plurality of systems having no right to use a first frequency band, the system comprising:
a coexistence manager (CM) configured to manage the plurality of systems for the purpose of existence and frequency sharing of the plurality of systems in a frequency band available for the plurality of systems, when the available frequency band is detected in the first frequency band;
a coexistence enabler (CE) configured to transmit/receive information of the plurality of systems; and
a coexistence discovery and information server (CDIS) configured to support a control of the CM for the plurality of systems,
wherein the information of the plurality of systems are transmitted/received between the CM, the CE and the CDIS according to interfaces defined between the CM, the CE and the CDIS, and each of the CM, the CE and the CDIS comprises a service access point (SAP) for supporting the transmission/reception of the plurality of systems through the interfaces.

2. The system of claim 1, wherein the information of the plurality of systems comprises context information, reset related information and event information.

3. The system of claim 2, wherein the CM, the CE and the CDIS transmit/receive the context information, the reset related information and the event information through primitives of the SAPs.

4. The system of claim 3, wherein the primitives of the SAPs comprise at least one of TVDB identifier (TVBD_ID), TVBD type (TVBD_Type), TVBD radio interface (TVBD_Radio_Interface), TVBD options (TVBD_Options), TVBD location information (TVBD_Location), TVBD measurement information (TVBD_Measurements), TVBD sensing threshold (TVBD_Sensing_Threshold), TVBD transmit power level (TVBD_Transmit_Power_Level, TVBD cell area (TVBD_Coverage_Area) and TVBD reset capability information (TVBD_Reconfiguration_Options of the plurality of systems, for the purpose of transmission/reception of the context information.

5. The system of claim 3, wherein the primitives of the SAPs comprise at least one of TVBD channel assignment (TVBD_Channel_Assignment), TVBD time scheduling assignment (TVBD_Time_Scheduling_Assignment), TVBD sensing threshold assignment (TVBD_Sensing_Threshold_Assignment), TVBD transmit power level assignment (TVBD_Transmit_Power_Level_Assignment) and TVBD cell area assignment (TVBD_Coverage_Area_Assignment) of the plurality of systems, for the purpose of transmission/reception of the reset related information.

6. The system of claim 3, wherein the primitives of the SAPs comprise at least one of TVBD location change information (TVBD_Location_Change), TVBD measurement information (TVBD_Measurements_Change), incumbent detection information in an operating frequency (TVBD_Incumbent_User_Detect) and secondary user detection information in the operating frequency (TVBD_Secondary_User_Detect) of the plurality of systems, for the purpose of transmission/reception of the event information.

7. The system of claim 1, wherein the CM determines operation frequency assignment, transmit power assignment and transmit time assignment of the plurality of systems in the available frequency band, and transmits/receives the context information, reset related information and event information of the plurality of systems.

8. The system of claim 7, wherein the CE transmits/receives the context information, reset related information and event information of the plurality of systems to/from the CM in the available frequency band, and the context information of the plurality of systems comprise information on radio access method, transmit power, spectrum sensing threshold and location of the plurality of systems.

9. The system of claim 1, wherein the SAPs comprise a device entity SAP, a device management entity SAP and a coexistence device management entity SAP.

10. The system of claim 1, wherein the plurality of systems use the available frequency band by transmitting/receiving the information according to the support of the SAPs through the interfaces for the purpose of the coexistence and frequency sharing of the plurality of systems.

11. A resource management method for managing a resource of a first frequency band in a communication system comprising a plurality of systems having no right to use the first frequency band, the method comprising:
defining interfaces between objects in a frequency band available for the plurality of systems for the purpose of existence and frequency sharing of the plurality of systems in the available frequency band, when the available frequency band is detected in the first frequency band;
defining primitives of SAPs for supporting transmission/reception of information of the plurality of systems between the objects through the interfaces;
transmitting/receiving, by the objects, the information of the plurality of systems using the primitives of the SAPs through the interfaces; and
using, by the plurality of systems, the available frequency band by transmitting/receiving the information of the plurality of systems for the purpose of coexistence and frequency sharing of the plurality of systems in the available frequency band.

12. The method of claim 11, wherein the information of the plurality of systems comprises context information, reset related information and event information.

13. The method of claim 12, wherein the object comprises a CM, a CE and a CDIS.

14. The method of claim 13, wherein, in the transmitting/receiving of the information of the plurality of systems, the CM, the CE and the CDIS transmit/receive the context information, the reset related information and the event information through primitives of the SAPs.

15. The method of claim 14, wherein the primitives of the SAPs comprise at least one of TVDB identifier (TVBD_ID), TVBD type (TVBD_Type), TVBD radio interface (TVBD_Radio_Interface), TVBD options (TVBD_Options), TVBD location information (TVBD_Location), TVBD measurement information (TVBD_Measurements), TVBD sensing threshold (TVBD_Sensing_Threshold), TVBD transmit power level (TVBD_Transmit_Power_Level, TVBD cell area (TVBD_Coverage_Area) and TVBD reset capability information (TVBD_Reconfiguration_Options of the plurality of systems, for the purpose of transmission/reception of the context information.

16. The method of claim 14, wherein the primitives of the SAPs comprise at least one of TVBD channel assignment (TVBD_Channel_Assignment), TVBD time scheduling assignment (TVBD_Time_Scheduling_Assignment), TVBD sensing threshold assignment (TVBD_Sensing_Threshold_Assignment), TVBD transmit power level assignment (TVBD_Transmit_Power Level_Assignment) and TVBD cell area assignment (TVBD_Coverage_Area_Assignment) of the plurality of systems, for the purpose of transmission/reception of the reset related information.

17. The method of claim 14, wherein the primitives of the SAPs comprise at least one of TVBD location change information (TVBD_Location_Change), TVBD measurement information (TVBD_Measurements_Change), incumbent detection information in an operating frequency (TVBD_Incumbent_User_Detect) and secondary user detection information in the operating frequency (TVBD_Secondary_User_Detect) of the plurality of systems, for the purpose of transmission/reception of the event information.

18. The method of claim 13, wherein the CM determines operation frequency assignment, transmit power assignment and transmit time assignment of the plurality of systems in the available frequency band, and transmits/receives the context information, reset related information and event information of the plurality of systems.

19. The method of claim 18, wherein the CE transmits/receives the context information, reset related information and event information of the plurality of systems to/from the CM in the available frequency band, and the context information of the plurality of systems comprise information on radio access method, transmit power, spectrum sensing threshold and location of the plurality of systems.

20. The method of claim 11, wherein the SAPs comprise a device entity SAP, a device management entity SAP and a coexistence device management entity SAP.
